(19) United States
(12) Patent Application Publication
(10) Pub. No.: US 2011/0290221 A1
(43) Pub. Date: Dec. 1, 2011

(54) GAS SUPPLY MODULE

(76) Inventor: Frank Steuernagel, Stuttgart (DE)

(21) Appl. No.: 13/130,531

(22) PCT Filed: Oct. 16, 2009
(86) PCT No.: PCT/EP09/63550

§ 371 Date: May 20, 2011

(30) Foreign Application Priority Data
Nov. 21, 2008 (DE) 10 2008 043 976.2

(51) Int. Cl. F02B 43/00; B65D 51/16

(52) U.S. Cl. 123/527; 220/202

(57) ABSTRACT

A gas supply module is described for supplying a combustion chamber of an internal combustion engine with gas, in particular with air, including a gas supply element for supplying gas to the combustion chamber and a closure element which is situated in the gas supply element on the outlet side, the gas supply element being closable in a gas-tight manner on its outlet side with the aid of closure element.

### BACKGROUND INFORMATION

The present invention relates to issues involving the supply of air to internal combustion engines.

In vehicles conventionally driven by internal combustion engines, different combustion chamber pressures are generated which, since the drive torque curve is normally constant, may be constantly increased or decreased, for providing different drive torques with the aid of the internal combustion engine. In modern hybrid vehicles, on the other hand, the drive torques are delivered, for example, from several drive sources, for example electric motors and internal combustion engines, operating either in combination or separately. If, for example, an electric motor is driving a hybrid vehicle, the vehicle's range is limited by the amount of electrical energy available or by the physical performance of the electric motor. If the hybrid vehicle may no longer be driven exclusively by the electric motor, the internal combustion engine is coupled and started. If, however, the internal combustion engine is no longer needed, it is decoupled.

In parallel hybrid power trains of a parallel hybrid vehicle, the coupling and decoupling of the internal combustion engine occur by engaging and disengaging a separating clutch between the internal combustion engine and the electric motor and the subsequent starting or stopping of the internal combustion engine. However, one challenge in coupling and decoupling of the internal combustion engine is that of making it start and stop smoothly and if possible imperceptibly, while also highly dynamically. If the internal combustion engine starts to operate or stops operating during the coupling or decoupling process, then initial injections of fuel and ignition operations, or final injections of fuel and ignition operations, respectively, are executed; during this process low rotational speeds of the internal combustion engine, and in some cases high angular accelerations, are also to be anticipated. If excessively high torque is generated by the internal combustion engine during the coupling or decoupling process, this results in an undesired and perceptible change in torque. In consequence, in hybrid vehicles, in particular parallel hybrid vehicles, at the transition between purely electric and hybrid drive the internal combustion engine in its starting phase is started by the electric motor, so that injection of fuel and ignition may take place at an adequately high engine speed. In order to ensure that starting the internal combustion engine has a neutral effect on torque, however, the internal combustion engine torque generated or needed must be compensated for by the electric motor during the start phase, so that the sum of the torques acting on an axle remains constant. If the internal combustion engine is started by the electric motor, then following the engagement of the separating clutch the internal combustion engine may be started with combustion-generated torque, in other words with an internal torque, this internal torque exactly matching the internal combustion-engine-related losses resulting, for example, from the friction within the internal combustion engine. This means that total torque generated by the internal combustion engine equates to 0 Nm, with the result that the electric motor does not have to perform any torque compensation.

The torque generated by the internal combustion engine during the start phase is strongly dependent on external conditions, in particular, such as for example the instantaneous charging of the cylinders' combustion chambers. Consequently, with an internal combustion engine, in particular a spark-ignition engine, there are essentially three variables for setting the instantaneous combustion-generated torque, namely the charge, for example the quantity of air, the quantity of fuel, and the ignition timing. In the case of the spark-ignition engine, limits are placed on the quantity of fuel and the ignition timing at a given charge, in order to guarantee provision of a combustible mixture. Similarly, in the case of a diesel engine, the relevant factors are the quantity of fuel and, in particular at the beginning of delivery, the injection point in time. For setting a high or low combustion-generated torque, a suitable charge is therefore preferably to be set by which an air pressure is generated in the cylinder which is relevant for the combustion-generated torque after injection of fuel and ignition.

In order to apply air pressure to the cylinders of an internal combustion engine, use is usually made of suction pipes, which are evacuated during start-up of the internal combustion engine, with the volume of the suction pipe determining the quantity of air enclosed in the suction pipe and thus the air pressure and therefore also the resultant combustion-generated torque. In order to charge the suction pipe with air, normally a throttle valve is fitted on the inlet end of the suction pipe, and for purposes of improved fuel-air mixing a swirl valve to generate a turbulence in the flow may also be used, as described in DE 10 2004 011 589 A1. For purposes of suction pipe evacuation, the charge in the suction pipe is reduced by diminishing the volume of air under ambient pressure in the suction pipe in response to the internal combustion engine's suction and emission processes.

With large suction pipe volumes, however, evacuating the suction pipe may take some seconds, which means that a rapid start of the internal combustion engine is not possible. Once the suction pipe is evacuated, then extremely low torque levels may be generated with the aid of the internal combustion engine. However, because of the lack of charge it is not possible to generate a high level of torque rapidly.

### SUMMARY OF THE INVENTION

The present invention is based on the finding that rapidly changing levels of torque may be generated by an internal combustion engine if its combustion chambers are supplied with different volumes of air, which will determine different combustion chamber pressures. If the combustion chamber of the internal combustion engine is supplied with air through the use of a gas supply element, such as for example a suction pipe, then relatively low levels of torque may be generated, if, for example, not the entire gas supply element is evacuated, but only, for example, the cylinders. That may be achieved by causing the gas supply element that is supplying air to the combustion chamber to have a closure not only on the inlet side, but also on the outlet side, at the end facing the combustion chamber and as close as possible to the cylinder, whereby an outlet-side volume of the gas supply element, in other words a volume between an outlet of the gas supply element and the closure on the outlet side, may be reduced. As a result of the lower air volume, a faster evacuation of the cylinders or of their combustion chambers may be achieved, as a result of which relatively low torque levels may be generated rapidly. If the closure on the outlet side is opened, then an increased air volume becomes available in the gas supply element, with the result that higher torque levels may be generated rapidly. It is preferable if the gas supply element is closable in a gas-tight manner preferably directly upstream from the cylinder, with the aid of the closure on the outlet side, thereby avoiding an evacuation of the gas supply element as far as a throttle valve that may be present on the inlet side, so that the volume of air to be evacuated is essentially determined only by the smaller volume of air present in the cylinder. Cylinder evacuation may also be performed with the aid of the closure element on the outlet side if the air supply module itself cannot be evacuated, as is the case for example with diesel engines in which non-closable inlet-side air supply elements are used.

One aspect of the present invention is that it concerns a gas supply module for supplying a combustion chamber of an internal combustion engine with gas, in particular with air, including a gas supply element for supplying gas to the combustion chamber and a closure element which is situated in the gas supply element on the outlet side, the gas supply element being closable in a gas-tight manner on the outlet side by the closure element. This provides a simple way of restricting the gas supply element's outlet-side volume in order to generate reduced torque levels.

In one specific embodiment, the gas supply module also includes an additional closure element, in particular an inlet-side throttle valve, which is situated in the gas supply element on the inlet side, the gas supply element being closable in a gas-tight manner on the inlet side by the additional closure element. This advantageously ensures that the gas supply element may simply and quickly supply different gas volumes, which will result in correspondingly different combustion chamber pressures. The gas supply element takes in particular the form of a gas pipe, with which the gas preferably may flow in on the inlet side and out on the outlet side. Thus the closure element is situated downstream from the additional closure element, in the direction of gas flow. The gas-tight design of the closable and openable closure elements also makes possible a reliable evacuation of the gas supply element.

In one specific embodiment the closure element is provided in order to reduce the gas supply element's outlet-side volume. Thereby it is advantageously ensured that the combustion chamber flanged to the gas supply element on the outlet side, for example, may be rapidly evacuated, as is required for generating low torque levels. It is preferable if the closure element is therefore situated directly at the outlet of the gas supply element, so that a gas volume between the closure element and the outlet of the gas supply element is small.

In one specific embodiment, on the other hand, the additional closure is provided in order to establish a preferably larger gas volume between the additional closure and the outlet of the gas supply element. Thereby it is advantageously ensured that, for example, after opening the closure element a higher gas volume is available, so that higher internal combustion-engine-generated torque levels may be generated.

In one specific embodiment the additional closure element is a throttle valve on the inlet side and the closure element a throttle valve on the outlet side. This ensures in an advantageous manner that the two closure elements may be constructed using standard components, and situated in the gas supply element.

In one specific embodiment the closure element and the additional closure element may be closed or opened independently of each other, thereby ensuring in an advantageous manner that the different gas volumes may be supplied independently of one another.

In one specific embodiment the gas supply element includes an additional closure element situated on the inlet side for closing the gas supply element in a gas-tight manner and a swirl valve to create turbulence in the gas. Thus the gas supply module has at least three closure elements.

In a further specific embodiment the gas supply module includes a plurality of gas supply elements for supplying a plurality of combustion chambers with gas, for example with air. In this design each gas supply element has on the outlet side a closure element for reducing the gas supply element's outlet-side volume. It is preferable if each gas supply element is linked on its outlet side with a combustion chamber of a cylinder, thereby making direct supply of gas to the combustion chambers possible.

In one specific embodiment the gas supply module includes a number of outlet-side closure elements, each of them being allocated to one cylinder. It is preferable if the outlet-side closure elements may be controlled independently of one another, so that they may be adjusted independently of one another. Thereby a first group of the outlet-side closure elements may be closed and a second group of the outlet-side closure elements may be opened, in order to permit control specific to each individual cylinder.

In one specific embodiment, the gas supply element is a suction pipe that may be evacuated, which provides the advantage that use may be made of standard components in order to manufacture the gas supply module.

A further aspect of the invention is that it relates to a method for operating an internal combustion engine having at least one combustion chamber and a gas supply module according to the present invention linked to the at least one combustion chamber. The method includes the closing of the closure element during a start phase of the internal combustion engine for reducing the volume of gas to be supplied to the combustion chamber.

In one specific embodiment, after a predetermined interval, for example after one second, two seconds, three seconds, five seconds or ten seconds, after the start phase of the internal combustion engine begins, the additional closure element is closed and the closure element opened, in order to increase the volume of gas to be supplied to the combustion chamber, whereby advantageously higher levels of torque may be generated by the internal combustion engine.

Further steps of the method arise directly from the functionality of the gas supply module according to the present invention.

A further aspect of the invention is that it concerns a software-driven device, for example a control unit, which is designed to run a computer program for executing the method for operating an internal combustion engine.

Further exemplary embodiments will be explained with reference to the attached drawings. The figures show:

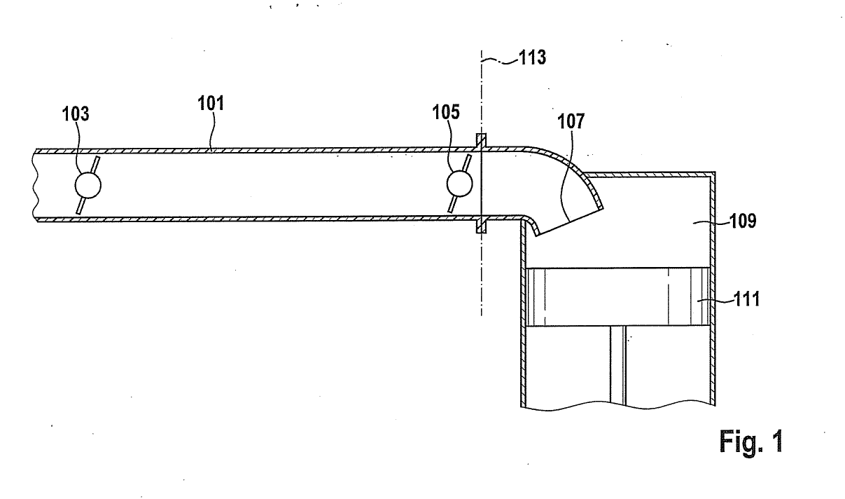

FIG. 1 a gas supply module; and

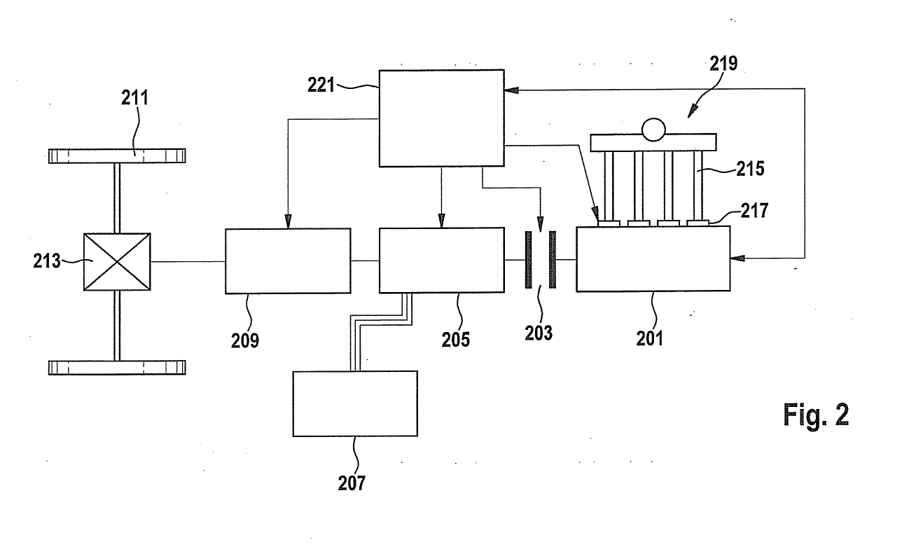

FIG. 2 a power train of a parallel hybrid drive.

FIG. 1 shows a gas supply module having a gas supply element 101, on whose inlet side an inlet-side closure element 103 and on whose outlet side an outlet-side closure element 105 are situated. The gas supply element may be a suction pipe, closure elements 103 and 105 then being throttle valves or suction pipe flaps. As shown in FIG. 1, the gas supply module is linked to a combustion chamber 109 of a cylinder with the aid of a connection element 107. In the interests of clarity a piston 111 in the cylinder is also shown, which brings about a compression of the gas in the combustion chamber.

As shown in FIG. 1, the gas supply module is connected on its outlet side to connection element 107 with the aid of connection interface 113, shown in FIG. 1, which may, for example, be a flange. Connection element 107 may, however, be a component of the gas supply module, so that closure element 105 may be shifted even further in the direction of combustion chamber 109, which may cause the outlet-side volume to be reduced even further.

By making use of closure element 105, a lower volume of gas is provided on the outlet side, which makes it possible for the internal combustion engine to start smoothly, owing to the low torque levels. Ideally, the internal combustion engine will start at an output torque of 0 Nm at an interface to a power train, for example a separating clutch to the electric motor, and will then increase the torque levels being generated in a controlled manner. By making use of outlet-side closure element 105 it is thus no longer necessary to evacuate the whole gas supply element 101 for example at relatively low engine speeds and in so doing to create extremely low output torque levels through the use of minimum injection quantities and late ignition. In order to produce relatively low torque levels, stratified injection may also be used, in which a mixture in the vicinity of the spark plugs is ignited late. According to the present invention the use of stratified injection is made possible with the aid of additional outlet-side closure element 105, although with stratified injection there is also a relationship between output torque and volumetric efficiency of the internal combustion engine and the combustible mixture. In the case of a low volumetric efficiency, therefore, only relatively low output torque levels may be created. If the volumetric efficiency is high, however, then relatively low output torque levels may be implemented only up to a limit of combustibility of the mixture. The lowest output torque levels during stratified operation are therefore lower than the output torque levels during conventional operation with a homogenous mixture. A further consequence of the volume reduction using outlet-side closure elements 105 is that due to a lean operation related to the stratified injection operation, normally very high emissions, for example of NOₓ, may be reduced.

If the gas supply element is a suction pipe, then closure element 105 may be a suction pipe flap, which for example may take the form of a swirl valve. By contrast with known swirl valves, which are intended to induce very strong turbulence in the mixture and consequently cannot completely close the cross section of the suction pipe, the closure element has the function of closing the tube so as to make it gas-tight, in order to make it possible to evacuate the outlet-side volume. Additional outlet-side closure element 105 may be used, for example, to close off a suction pipe at a point at which, for example, the suction pipe is flanged to the cylinder head, as is shown, for example, making use of connection interface 113. Further consequences of such a design are that the actual charge of the suction pipe is retained, throttle valve 103 does not have to be activated, and closure element 105 in its closed state closes off the respective cylinder from the suction pipe. If a gas supply module as shown in FIG. 1 is assigned to every cylinder of the internal combustion engine, then it is also possible to evacuate the individual cylinders considerably more quickly as a result of the reduced volumetric efficiency, without decreasing the volumetric efficiency needed for a rapid torque demand for the operation of the internal combustion engine following its start phase, because now it is essentially only the cylinder concerned that has to be evacuated, not several cylinders and the whole gas supply element. As a result of the reduced volumetric efficiencies in the cylinders, or rather in their combustion chambers, it is now also possible to create extremely low torque levels during operation with a homogenous mixture.

FIG. 2 shows a power train of a parallel hybrid vehicle having an internal combustion engine 201, which is coupleable via a separating clutch 203 to an electric motor 205. For supplying electric motor 205 with electrical energy, a vehicle battery 207 is provided. Electric motor 205 is coupled to a transmission 209, which has the function of driving front wheels 211 through a transfer case 213. The internal combustion engine has, for example, four cylinders, a gas supply element 215 being assigned to each cylinder. Each gas supply element 215 may be closed on its outlet side with the aid of a closure element 217, for example a suction pipe flap. Gas supply elements 215 and closure elements 217 together form a gas supply module 219. Additionally, a control unit 212 is provided for controlling closure elements 217, which is also coupled to separating clutch 203, to electric motor 205, to transmission 209 and to combustion engine 201.

Control unit 221 has the function, for example as required by a driving state, of opening or partially or fully closing closure elements 217, in order to supply a minimum air quantity, if, for example, starting internal combustion engine 201 does not result in successfully synchronizing the initial revolutions or achieving suitable injections of fuel and ignition operations, entailing the risk that a volumetric efficiency in the cylinders will no longer be high enough for a combustible mixture. In addition it is possible to have valve positions specific to each individual cylinder, in order to optimize initial injections of fuel and ignition operations individually for each cylinder.

If closure elements 217 are formed, for example, by suction pipe flaps, that has the advantage that by contrast with pure stratified operation the possibility is now offered of retrofitting appropriately designed internal combustion engines without major interference. In particular, it is conceivable to retrofit different hybrid variants of an internal combustion engine with the outlet-side suction pipe flaps.

Furthermore, in addition to controlling closure elements 217, control unit 221 has, for example, the function of carrying out a coordinated execution of the control of closure elements 217 during the start and stop phases during operation of the internal combustion engine. Control unit 221 may, for example, take the form of an engine control unit.

If, for example, the case of a stop of internal combustion engine 201 is considered, here it is preferable if an output torque of 0 Nm is created. In order to disengage internal combustion engine 201 from the power train, it is preferable if initially extremely low torque levels are created, in order, for example, to operate separating clutch 203 between internal combustion engine 201 and electric motor 205 under no load. Also in this application, however, closure elements 217 may assist in rapidly evacuating extremely small quantities of air in the cylinder in question, without an evacuation of the entire volume of each and every gas supply element being required.

There may be a need to start internal combustion engine 201, however, after an electric drive phase, if for example vehicle battery 207 has been severely discharged or an input from the driver may no longer be implemented by electric motor 205 alone. In such cases it is advantageous to shift internal combustion engine 201, very soon after it has been started, into a state in which it is able to deliver high torque levels. Here it is also conceivable that in order to charge the vehicle battery 207 a negative electrical torque of the generator may be created. In order to permit such a quasi-steady torque distribution, the torque levels may preferably be ramped up or down, with, for example, electric motor 205 switching over from acting as a motor to acting as a generator. In this switchover phase internal combustion engine 201 provides a high drive torque, in order to allow torque compensation. In order to provide the requisite dynamics the outlet-side closure elements according to the present invention may be controlled in interaction with the inlet-side throttle valves, so that, for example, torque shear is avoided. As a result of having a lower volume to be evacuated, there is also a smaller quantity of air directed to the exhaust, if outlet-side closure elements 217 are closed. This is also advantageous for the downstream catalytic converter, because the lower quantity of air means that it is cooled less, and because fewer reactions take place as a result of the lower quantity of oxygen available. This results in a further reduction in exhaust gases as internal combustion engine 201 is started. In addition it is preferable for individual control of the cylinders if the torque to be generated per cylinder is provided at an instantaneous cylinder charge, in order to be able to carry out cylinder-individualized control of outlet-side closure elements 217. Consequently, it is advantageous if control unit 221 is able to control outlet-side closure elements 217 individually, so that evacuation of the gas supply elements with the aid of outlet-side closure elements 217 may be performed efficiently.

The method according to the present invention may, for example, be performed if, for example, a vehicle coordinator element or a hybrid manager initiates a start of the internal combustion engine at a reduced torque, starting for example from purely electric drive. After that a start phase of the internal combustion engine begins, in which the latter, for example, is started. To that end separating clutch 203 is engaged and outlet-side closure elements 217 are closed, so that internal combustion engine 201 begins to turn. In this process, for example through the use of pressure sensors, a charge of gas supply elements 215 or of the cylinders may be observed, in particular with individual observation of each cylinder. After complete evacuation of gas supply elements 215 or after a reduction of the volume of air enclosed in them, separating clutch 203 is completely engaged, after which internal combustion engine 201 fires, for example. Following that, injection into each cylinder individually may be enabled, with the result that internal combustion engine 201 will fire on all cylinders, and, owing to the low air volume, extremely low torque levels may be generated. Depending on the torque level required, outlet-side closure elements 217 and the inlet-side throttle valves, not shown in FIG. 2, may be opened, thereby initiating an end of the start phase of internal combustion engine 201. After that, for purposes of the hybrid drive, the outlet-side closure elements may be completely opened, thereby making a quasi-steady torque distribution possible.

1-14. (canceled)

15. A gas supply module for supplying a combustion chamber of an internal combustion engine with a gas, comprising:
at least one gas supply element for supplying the gas to the combustion chamber; and
at least one closure element, which is situated in the gas supply element on an outlet side of the gas supply element;
wherein the gas supply element is closable in a gas-tight manner on the outlet side with the aid of the closure element.

16. The gas supply module of claim 15, further comprising:
an additional closure element, which includes a throttle valve, which is situated in the gas supply element on an inlet side, wherein the gas supply element on the inlet side is closable in a gas-tight manner with the aid of the closure element.

17. The gas supply module of claim 15, wherein the closure element is configured for reducing an outlet-side volume of the gas supply element.

18. The gas supply module of claim 15, further comprising:
an additional closure element to establish a gas volume between the additional closure element and an outlet of the gas supply element.

19. The gas supply module of claim 15, wherein the closure element includes a throttle valve on an outlet side.

20. The gas supply module of claim 15, further comprising:
an additional closure element on an inlet side of the gas supply element, wherein the closure element and the additional closure element are openable, closable or controllable independently of one another.

21. The gas supply module of claim 15, wherein the gas supply element has an additional closure element situated on an inlet side for gas-tight closing of the gas supply element, and wherein the gas supply element has a swirl valve to create turbulence in the gas.

22. The gas supply module of claim 15, wherein the at least one gas supply element includes a plurality of gas supply elements for supplying a plurality of combustion chambers with the gas, and wherein each gas supply element has a closure element on an outlet side for providing volume reduction.

23. The gas supply module of claim 15, wherein the at least one closure element includes a plurality of outlet-side closure elements, and wherein each of the outlet-side closure element is assigned to one cylinder of the internal combustion engine.

24. The gas supply module of claim 15, wherein the gas supply element includes an evacuatable suction pipe.

25. A method for operating an internal combustion engine having at least one combustion chamber, the method comprising:
closing at least one closure element during a start phase of the internal combustion engine for reducing a volume of gas to be supplied to the combustion chamber;
wherein a gas supply module is connected to the at least one combustion chamber, the gas supply module being configured for supplying a combustion chamber of an internal combustion engine with a gas, and including:
at least one gas supply element for supplying the gas to the at least one combustion chamber; and
the at least one closure element, which is situated in the gas supply element on an outlet side of the gas supply element;
wherein the gas supply element is closable in a gas-tight manner on the outlet side with the aid of the closure element.

26. The method of claim 25, wherein following a predetermined time interval after the beginning of the start phase, an additional closure element situated on the inlet side of the gas supply module remains closed or is closed and the closure element is opened to increase the volume.

27. The method of claim 25, wherein the internal combustion engine in the start phase is mechanically driven by an additional drive source, which includes an electric motor, and wherein the closure element is opened once ignition has taken place to obtain a higher level of combustion-generated torque.

28. A control unit, comprising:
a computer readable medium having a processor and a computer program, which is executable by the processor, the computer program including a program code arrangement having program code for operating an internal combustion engine having at least one combustion chamber, by performing the following:
closing at least one closure element during a start phase of the internal combustion engine for reducing a volume of gas to be supplied to the combustion chamber, wherein a gas supply module is connected to the at least one combustion chamber, the gas supply module being configured for supplying a combustion chamber of an internal combustion engine with a gas, and including:
at least one gas supply element for supplying the gas to the at least one combustion chamber; and
the at least one closure element, which is situated in the gas supply element on an outlet side of the gas supply element;
wherein the gas supply element is closable in a gas-tight manner on the outlet side with the aid of the closure element.
